(19) United States
(12) Patent Application Publication
(10) Pub. No.: US 2005/0061121 A1
(43) Pub. Date: Mar. 24, 2005

(54) Bushings with sacrificial end caps and shims for axially positioning rotating slotting and scoring wheels

(76) Inventor: David Lauderbaugh, Cumming, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 10/668,826

(22) Filed: Sep. 23, 2003

(51) Int. Cl. B26D 1/00

(52) U.S. Cl. 83/13

(57) ABSTRACT

A bushing used in a machine for scoring or slotting sheets of material using rotating wheels. The bushing, which is used to move a rotating scoring or slotting wheel in an axial direction, includes a housing configured for support by a yoke that moves axially to impart axial movement to the wheel while the wheel rotates. The bushing also includes a sacrificial end cap, which is supported by the housing, that is configured for replacement without replacing the housing. Each yoke typically supports a number of such bushings, and bushing typically supports a pair of sacrificial end caps to permit bidirectional movement of the rotating wheel. Shims may also be placed between an end cap and its associated housing to offset wear of the end cap.

### TECHNICAL FIELD

The present invention relates to machines for scoring and slotting corrugated board and, more particularly, relates to a bushing having sacrificial end caps and shims for changing the axial position of rotating scoring and slotting dies and anvils.

### BACKGROUND OF THE INVENTION

For many years, scoring and slotting machines have been used to impress score lines and cut slots in sheets of corrugated board as the sheets are conveyed through the machine. Scoring and slotting machines are referred to generally as “slotters” or “creaser-slotters” because the only difference between a scoring or creasing operation and a slotting operation is the type of die used to operate on the board. A slotting machine section is often combined with a printing section to create printer-slotter machine, and may also be found in folder/gluer machines, as is well known in corrugated board industry.

Each slotter includes a number of large rotating wheels commonly referred to dies, heads or knives. The various types of scoring and slotting wheels will be referred to generally as “dies” for descriptive convenience. Each die rotates adjacent to another rotating wheel, commonly referred to as an anvil. The sheets of corrugated board are scored or slotted as they are conveyed through a nip defined by the die and its associated anvil. Each slotter typically includes about four to six dies spaced apart on a common shaft. The dies are positioned adjacent to associated anvils, which are also on their own common shaft. Both shafts are typically powered by a common drive train to ensure that the sheets are conveyed in a straight manner through the machine while maintaining proper registration of the sheets with respect to the dies. This basic slotter configuration has been in commercial use for many years, and can be found in the slotter and printer-slotter machines manufactured by Langston Greenwood, Floxo Foldfer/Gluer machines manufactured by Ward Machinery, and a number of other machines offered by these and other manufacturers.

It is also well known to equip a slotter machine for axial movement of the dies and anvils. This allows the position of the score lines and slots to be adjusted across the width of the machine to accommodate different jobs. Slotters are typically configured to move the rotating wheels axially while the wheels continue rotating to avoid having to shut down the machine to reposition the dies and anvils. To implement the desired movement, a device known as a yoke is used to push the rotating wheel axially while the wheel rotates. The yoke, which is driven in the axial direction by a ball screw or another suitable drive mechanism, pushes its associated rotating wheel along as it travels back and forth in the axial direction. A local or remote controller directs the operation of the yoke drive unit to position the rotating wheels as desired. This basic axial positioning system has also been in use for many years.

The system described above has a drawback in that the yoke caries a number of bushings that contact and push against the rotating wheels. These bushings, which are typically manufactured from carbon or carbon impregnated NYLON®, wear out over time and must be replaced. In conventional slotters, the entire bushing is removed from the yoke and discarded even though only the ends where the bushing contacts the rotating wheel is worn. Each bushing typically cost in the range of $30, and each slotter includes about 24 to 36 bushings. The resulting cost of bushing replacement can mount to a significant sum. Accordingly, there is an ongoing need for a more cost effective bushing system for slotters with rotating wheels configured for axial movement.

### SUMMARY OF THE INVENTION

The present invention meets the needs described above in a slotter bushing including a housing and sacrificial end caps. This allows the sacrificial end caps, rather than the entire bushing, to be replaced as needed. The invention also includes a system of shims that can be placed between the sacrificial end cap and the housing to bias the end cap outward to offset wear, and thus extend the useful life of the end cap. In this manner, the invention eliminates the waste associated with discarding the entire bushing, as has been practiced with conventional slotter bushings for many years.

Generally described, the invention may be realized in a bushing used in a machine for scoring or slotting sheets of material using rotating wheels. The bushing, which is used to move a rotating scoring or slotting wheel in an axial direction, includes a housing configured for support by a yoke that moves axially to impart axial movement to the wheel while the wheel rotates. The bushing also includes a sacrificial end cap, which is supported by the housing, that is configured for replacement without replacing the housing. Each yoke typically supports a number of such bushings, and each bushing typically supports a pair of sacrificial end caps to permit bidirectional movement of the rotating wheel. Shims may also be placed between an end cap and its associated housing to offset wear of the end cap.

More specifically described, the bushing may include a housing nut configured to threadably engage a yoke that is used to axially position a rotating wheel that is used for scoring or slotting sheets of material as the sheets are conveyed past the rotating wheel. The housing nut supports a first sacrificial end cap configured to contact the rotating wheel under force exerted by the yoke to position the rotating wheel in a first axial direction. The housing nut also supports a second sacrificial end cap configured to contact the rotating wheel under force exerted by the yoke to position the rotating wheel in a second axial direction. One or more retainers removably hold the first and second end caps to the housing. Again, one or more shims may be located between the end caps and the housing to offset wear of the end caps.

In particular, the machine typically includes a die that rotates about an about an axis. The machine also includes a yoke for axially positioning the die, and a drive for changing the axial position of the yoke and thereby changing the axial position of the die. The machine also includes a bushing for translating axial movement of the yoke to axial movement of the rotating wheel, comprising a housing engaged with the yoke, a sacrificial end cap supported by the housing, and a retainer removably holding the end cap to the housing. The housing may support a second sacrificial end cap to permit bidirectional axial movement of the die. The yoke may support a number of similar bushings, and each housing may support a pair of sacrificial end caps.

The machine may also include a number of similar dies, with each die having an associated yoke, each yoke supporting a number of bushings, and each bushing having a housing supporting a pair of sacrificial end caps to permit bidirectional axial movement of the associated die. Further, the machine may also include a number of similar anvils, with each anvil opposing a corresponding die. In this case, each anvil may have an associated yoke, each yoke may support a plurality of bushings, and each bushing may include a housing supporting a pair of sacrificial end caps to permit bidirectional axial movement of the associated anvil.

Accordingly, it should be understood that the invention may be practiced as a set of bushings with sacrificial end-caps, as a slotter machine including a set of these bushings, or as a method for axially positioning a rotating wheel using these bearings. In view of the foregoing, it will be appreciated that the present invention provides an improved set of bushings for axially moving rotating wheel in slotter machines. The specific techniques and structures for implementing the improved bushing system, and thereby accomplishing the advantages described above, will become apparent from the following detailed description of the embodiments and the appended drawings and claims.

### BRIEF DESCRIPTION OF THE DRAWINGS

FIG. 1 is a conceptual illustration of a slotter machine including bushings with sacrificial end caps.

FIG. 2 is a conceptual illustration of the slotter machine of FIG. 1 after an illustrative die and anvil have been moved in an axial direction.

FIG. 3 is a perspective view of a yoke and ball screw mechanism for axial moving rotating wheels in a typical slotter.

FIG. 4 is a front view of a slotter showing the locations of the bushings used to move the rotating wheels in an axial direction.

FIG. 5 is an end view of a bushing with sacrificial end caps.

FIG. 6 is a crosssection side view of the bushing of FIG. 4 showing typical dimensions.

FIG. 7 is an end view of an end cap showing typical dimensions.

FIG. 8 is a side crosssection side view of the end cap of FIG. 7 showing typical dimensions.

### DETAILED DESCRIPTION OF THE EMBODIMENTS

The present invention may be embodied in a bushing including a pair of opposing disposable end caps. A number of these bushings are configured to screw into a yoke that fits into a shoe that is part of a rotating die or anvil in a slotting machine. The yoke may then be moved axially, for example using a ball screw drive assembly, to move the die or anvil axially. In this configuration, the disposable end caps experience frictional wear from contacting and pushing against the rotating shoe. For this reason, the end caps periodically wear out and must be replace. A system of shims may also be provided for insertion under the end caps to extend the life of the these component.

The particular embodiment of a threaded bushing with a pair of disposable end caps described below is configured to replace the original disposable bushings in various models of the Ward Flexo Folder/Gluer. The new bushings allows only the disposable end caps, rather than the entire bushing, to be replaced when worn out. Similar bushings with disposable end caps may be configured for machines other than the Ward line of machines. Basically, any type of scoring, slotting, creasing or folding machine with disposable bushings could benefit from the use of disposable end caps. All of these machines may be referred to collectively as “slotters” because the only difference between the various operations is the profile of the die and anvil. Variations of the new bushings may also find application in other machines with rotating wheels configured for axial movement. In addition, the particular bushings described below include a pair of disposable end caps to facilitate wheel movement in both axial directions. However, a bushing with a single end cap may be appropriate for other pieces of machinery.

The end caps described below are typically manufactured from carbon or a carbon impregnated polymeric material, such as NYLON® or TELON®. However, any suitable sacrificial material may be used, and the selection of a particular sacrificial material will be a design choice based on the particular machine configuration and operating parameters. In addition, the particular end caps and shims are disk-shaped in the exemplary embodiment described below, but may be manufactured in other shapes and sizes as a matter of design choice.

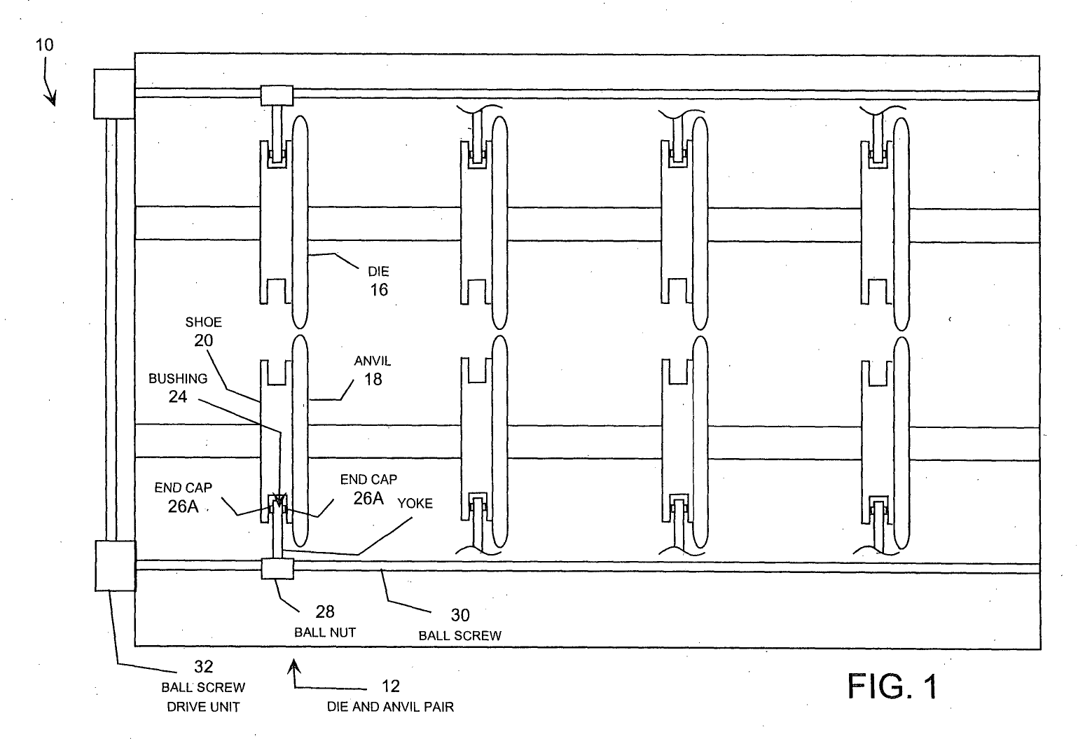

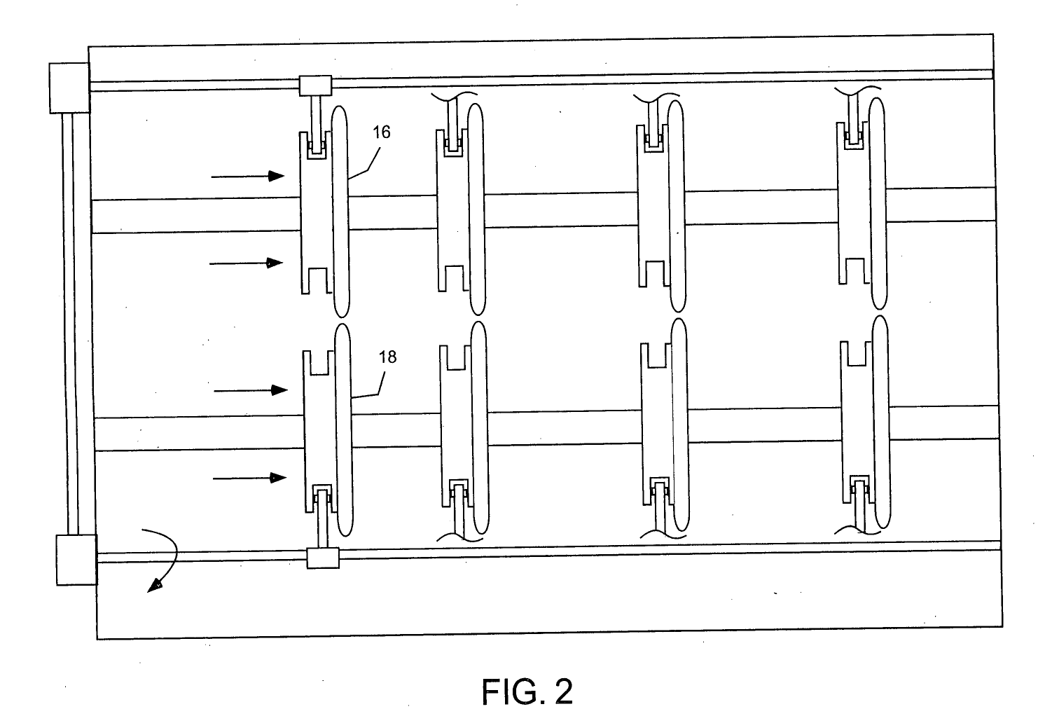

Turning now to the figures, in which like numerals refer to similar elements throughout the several figures, FIG. 1 is a conceptual illustration of a slotter machine 10 including bushings with sacrificial end caps. FIG. 2 is a conceptual illustration of the slotter machine of FIG. 1 after an illustrative die and anvil pair 12 has been moved in an axial direction. This particular slotter machine includes four dies with opposing anvils. The die and anvil pairs are similarly equipped and, for this reason, only one die and one anvil pair 12 is labeled for illustrative convenience. In addition, the bushing system is similar for the die and the anvil, and for this reason will only be described with reference to the anvil 18. The anvil carries a shoe 20 with a slot for receiving a yoke 22. The yoke includes a number of threaded holes that each receive a bushing 24, which carries a pair of opposing disposable end caps 26A-B. The yoke is supported by a ball nut 28 that is captured on a ball screw 30. A ball screw drive unit 32 selectively rotates the ball screw 30, which causes the ball nut 28 to travel axially along the ball screw. The ball nut 28 thus drives the yoke 22, which in turn drives the anvil 18 axially. Typically, a die and anvil pair is actuated by a common ball screw drive unit to ensure that the die moves axially together with its associated anvil. Each die and anvil pair typically has its own associated ball screw drive unit to permit independent positioning of each pair.

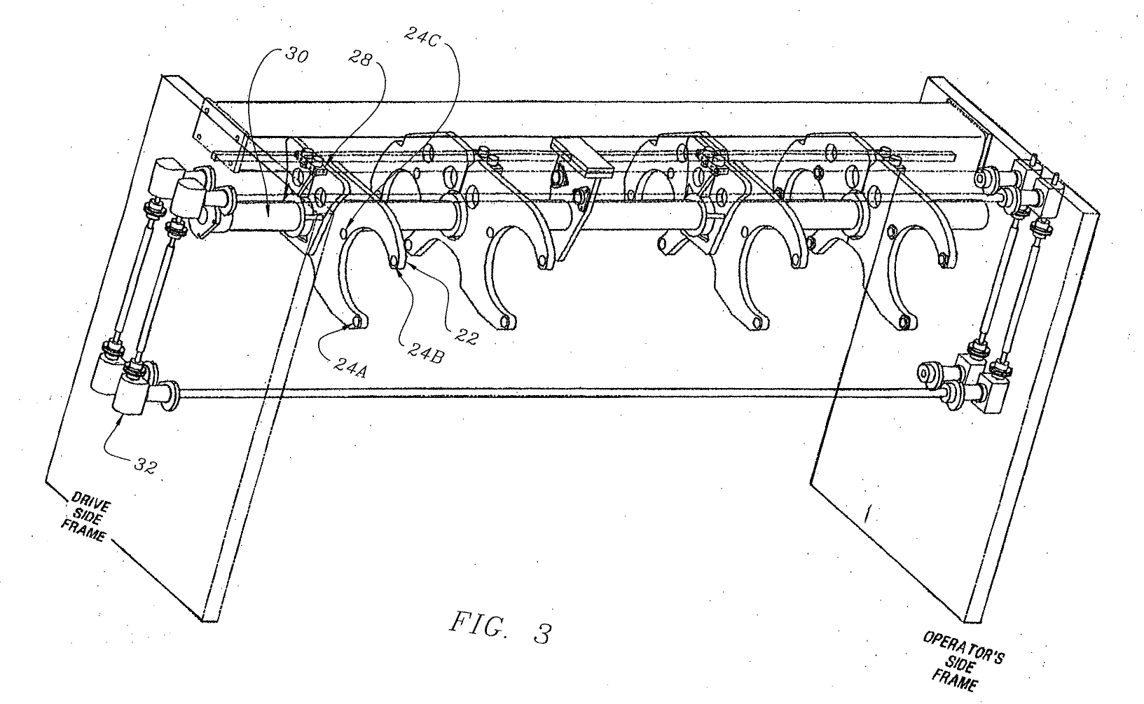

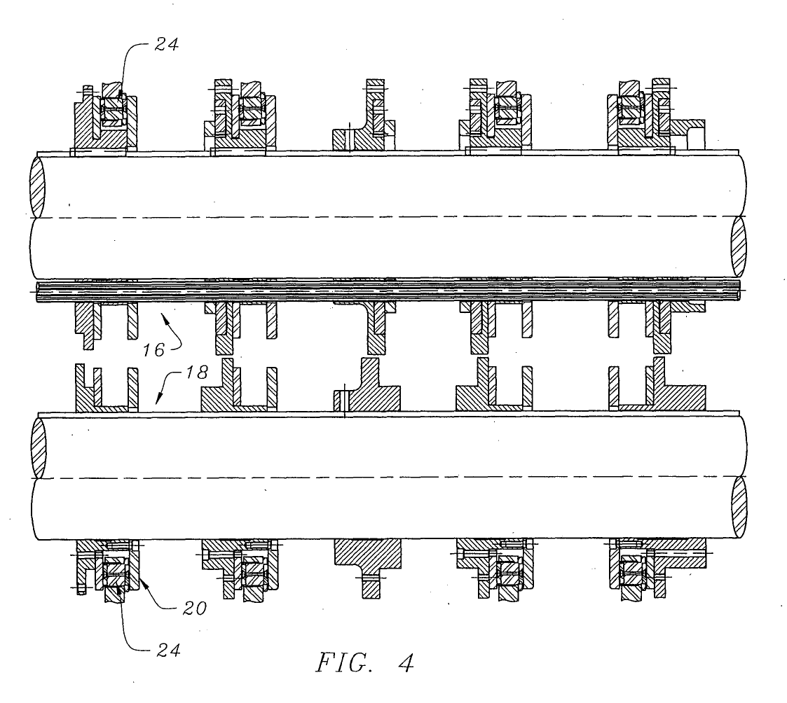

FIG. 3 is a perspective view of the yoke and ball screw mechanism for an illustrative Ward Flexo Folder/Gluer. This illustration shows a particular embodiment of the yoke 22 in greater detail. As shown in FIG. 3, this particular yoke includes three bushings 24A-C. Of course, different yoke configurations carrying different numbers of bushings may occur in different pieces of machinery. However, the Ward Flexo Folder/Gluer is a popular make with a range of models that can all use the particular bushings described in this specification, and for this reason it serves well as a exemplary embodiment of the present invention. FIG. 4 is a front view of a slotter section of the Ward Flexo Folder/Gluer showing the locations of the bushings 24 used to move the rotating wheels in an axial direction.

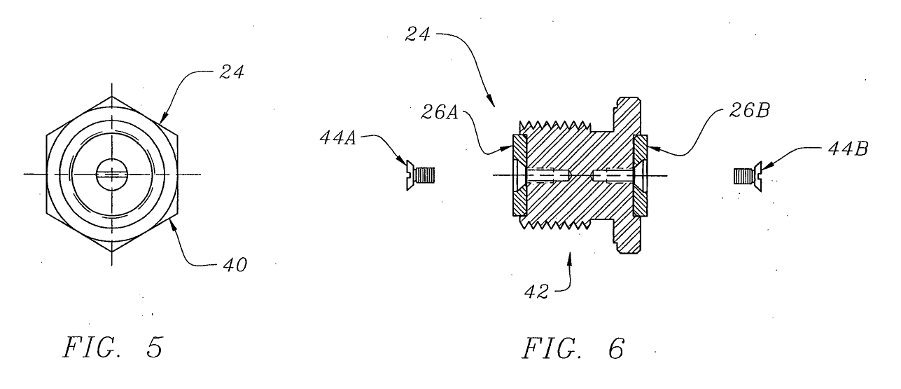

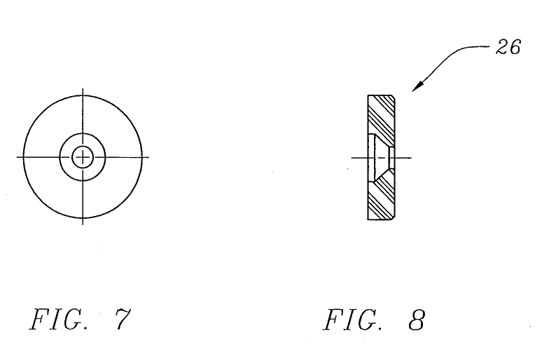

FIG. 4 is an end view and FIG. 5 a crosssection side view of the bushing 24 with sacrificial end caps 26A-B. The bushing 24 includes hexagonal head 40 and a cylindrical housing 42, which is threaded to screw into the yoke 22 (shown best in FIG. 3). The housing 42 includes a pair of opposing shallow disk-shaped cavities configured to receive the pair of opposing disk-shaped disposable end caps 26A-B. Each end cap is held in place by an associated screw 44A-B. In addition, each end cap extends outward beyond its associated cavity to provide an exposed portion of sacrificial end cap material for contacting the rotating shoe of a die or anvil. Disk-shaped shims of various thickness may be inserted into one or both of the cavities to offset wear of associated end caps. Typical dimensions expressed in inches are shown on FIG. 5, which is drawn to scale. FIG. 6 is an end view and FIG. 7 is a side crosssection side view of an end cap 26 showing typical dimensions. These figures are also drawn to scale.

In view of the foregoing, it will be appreciated that present invention provides significant improvements in axial movement bushings for dies and anvils in slotter machines. It should be understood that the foregoing relates only to the exemplary embodiments of the present invention, and that numerous changes may be made therein without departing from the spirit and scope of the invention as defined by the following claims.

1. A bushing for moving a rotating scoring or slotting wheel in an axial direction, comprising:
a housing configured for support by a yoke that moves axially to impart axial movement to the wheel while the wheel rotates;
a sacrificial end cap supported by the housing; and
the end cap configured for replacement without replacing the housing.

2. In or for a machine for scoring or slotting sheets of material using rotating wheels, wherein each wheels is configured for axial movement under force applied by an associated yoke, an improved set of bushings comprising:
a plurality of housings removably supported by each yoke;
each housing removably supporting a sacrificial end cap that is configured to contact its associated rotating wheel to impart said axial movement; and
each sacrificial end cap configured for replacement when worn without having to replace its associated housing.

3. The machine of claim 2, wherein each housing supports a second sacrificial end cap to permit bidirectional axial movement of its associated wheel.

4. The machine of claim 2, further comprising a plurality of shims configured for placement between an end cap and its associated housing to offset wear of the end cap.

5. A bushing for axially positioning a rotating wheel, comprising:
a housing configured for engagement with a yoke that is used to axially position a rotating wheel that is used for scoring or slotting sheets of material as the sheets are conveyed past the rotating wheel;
a sacrificial end cap configured for receipt by the housing and, when supported by the housing, configured to contact the rotating wheel under force exerted by the yoke to axially position the rotating wheel; and
a retainer configured to removably hold the end cap to the housing.

6. The bushing of claim 5, further comprising one or more shims configured for location between the end cap and the housing to offset wear of the end cap.

7. The bushing of claim 5, wherein the housing is configured to receive a second end cap to permit bidirectional positioning of the wheel.

8. The bushing of claim 5, wherein the end cap comprises a nut configured to threadably engage a socket through the yoke.

9. A bushing for axially positioning a rotating wheel, comprising:
a housing nut configured to threadably engage a yoke that is used to axially position a rotating wheel that is used for scoring or slotting sheets of material as the sheets are conveyed past the rotating wheel;
a first sacrificial end cap configured for receipt by the housing nut and, when supported by the housing nut, configured to contact the rotating wheel under force exerted by the yoke to position the rotating wheel in a first axial direction;
a second sacrificial end cap configured for receipt by the housing nut and, when supported by the housing nut, configured to contact the rotating wheel under force exerted by the yoke to position the rotating wheel in a second axial direction;
one or more retainers configured to removably hold the first and second end caps to the housing.

10. The bushing of claim 9, further comprising one or more shims configured for location between the end caps and the housing to offset wear of the end caps.

11. A machine for scoring or slotting sheets of material as the sheets are conveyed through the machine, comprising:
a die for scoring or slotting the sheets rotating about an about an axis;
a yoke for axially positioning the die;
a drive for changing the axial position of the yoke and thereby changing the axial position of the die; and
a bushing for translating axial movement of the yoke to axial movement of the rotating wheel, comprising a housing engaged with the yoke, a sacrificial end cap supported by the housing, and a retainer removably holding the end cap to the housing.

12. The machine of claim 11, wherein the housing supports a second sacrificial end cap to permit bidirectional axial movement of the die.

13. The machine of claim 12, wherein the yoke supports a plurality of similar bushings, each comprising a housing supporting a pair of sacrificial end caps.

14. The machine of claim 13, further comprising a plurality of similar dies, each die having an associated yoke, each yoke supporting a plurality of bushings, and each bushing comprising a housing supporting a pair of sacrificial end caps to permit bidirectional axial movement of the associated die.

15. The machine of claim 14, further comprising a plurality of similar anvils, each anvil opposing a corresponding die, each anvil having an associated yoke, each yoke supporting a plurality of bushings, and each bushing comprising a housing supporting a pair of sacrificial end caps to permit bidirectional axial movement of the associated anvil.

16. The machine of claim 15, further comprising a shim located between one of the end caps its associated housing to offset wear of the end cap.

17. A method for axially positioning a rotating wheel in a machine for slotting or scoring sheets of material, comprising the steps of:
installing a bushing into a yoke that is configured to axially position the rotating wheel, the bushing comprising a housing and a sacrificial end cap configured for receipt by the housing;
positioning the yoke such that the end cap is in adjacent to the rotating wheel;
changing the axial position of the yoke and thereby changing the axial position of the rotating wheel.

18. The method of claim 17, further comprising the step of removing a worn end cap from the housing and installing a replacement end cap in the housing.

19. The method of claim 18, further comprising the step of providing a set of shims for location between the housing and the end cap to offset wear of the end cap.

20. The method of claim 19, further comprising the step of inserting a shim between the housing and the end cap to offset wear of the end cap.
